(19) United States
(12) Patent Application Publication
(10) Pub. No.: US 2020/0260172 A1
(43) Pub. Date: Aug. 13, 2020

(54) ACOUSTIC EAR FITTING

(71) Applicant: W. L. Gore & Associates, Inc., Newark, DE (US)

(72) Inventors: Benjamin A. Smith, Flagstaff, AZ (US); Michael J. Vonesh, Flagstaff, AZ (US)

(21) Appl. No.: 16/753,142

(22) PCT Filed: Oct. 2, 2018
(86) PCT No.: PCT/US2018/053975

§ 371 Date: Apr. 2, 2020

Related U.S. Application Data
(60) Provisional application No. 62/567,394, filed on Oct. 3, 2017.

(51) Int. Cl. H04R 1/10; G10K 11/162; H04R 1/08; H04R 1/02

(52) U.S. Cl. CPC H04R 1/1016; H04R 1/023; H04R 1/086; G10K 11/162

(57) ABSTRACT

Ear fittings are disclosed. In various embodiments, an acoustic ear fitting includes a core member and a composite cover that is coupled to the core member. The composite cover may be permeable to air and/or moisture, while remaining liquid impermeable. In some examples, an elastomer may be present in the membrane, and may help maintain the microstructure of the porous fluoropolymer membrane. In some examples, the composite cover may be configured to be acoustically transparent, while in other examples the composite cover may be configured to acoustically enhance one or more signals.

### CROSS-REFERENCE TO RELATED APPLICATION

This application claims the benefit of Provisional Application No. 62/567,394, filed Oct. 3, 2017, which is incorporated herein by reference in its entirety for all purposes.

### BACKGROUND

A number of different electronic devices exist that are configured to deliver acoustic energy into the ear canal of a listener. Many of these devices incorporate ear fittings that are configured to fit within and deliver acoustic energy directly to the ear canal. Conventional ear fittings are made of a variety of materials and incorporate a wide array of designs. Generally, such ear fittings are shaped and designed for placement within the ear canal. Designs attempt to balance performance with comfort and durability. Some designs expose the ear canal to the outside environment while other designs isolate the ear canal from the outside environment. Each of these designs is associated with drawbacks.

For instance, designs that isolate the ear canal from the outside environment suffer from an undesirable acoustic characteristic known as the occlusion effect, which causes the listener or user to perceive low frequency or base sounds to be louder and possibly more distorted (e.g., the user's own voice, chewing, other jaw movement etc.).

In an effort to avoid the occlusion effect, some conventional designs incorporate open areas within the ear fitting to allow some of the acoustic energy delivered to the ear canal to escape. However, these open areas or pathways may promote other undesirable acoustic effects, such as parasitic or sound distorting resonances, which can degrade acoustic performance. In addition, such open areas or pathways expose the electronic components of the device to the surrounding environment, including moisture.

### SUMMARY

According to an example (“Example 1”) an acoustic ear fitting includes a core member, and a composite cover coupled to the core member, the composite cover being permeable to air, the composite cover being comprised of a porous fluoropolymer membrane having a microstructure including a fold and an elastomer applied to a portion of less than all of the porous fluoropolymer membrane, the elastomer operating to restore the microstructure of the porous fluoropolymer membrane including the fold after a force causing a deformation of the porous fluoropolymer membrane is removed.

According to another example (“Example 2”) further to Example 1, the composite cover is acoustically transparent.

According to another example (“Example 3”) further to Example 1, the composite cover is acoustically enhancing.

According to another example (“Example 4”) further to any of Examples 2 to 3, the composite cover operates to provide ambient noise isolation.

According to another example (“Example 5”) further to any of the preceding Examples, moisture is free to pass through the composite cover and exit a user's ear canal.

According to another example (“Example 6”) further to any of the preceding Examples, the composite cover is vapor permeable.

According to another example (“Example 7”) further to any of the preceding Examples, the composite cover is liquid impermeable.

According to another example (“Example 8”) further to any of the preceding Examples, the core member is comprised of a foam.

According to another example (“Example 9”) further to Example 8, the foam is elastomeric.

According to another example (“Example 10”) further to any of Examples 8 or 9, the composite cover is mounted within the foam.

According to another example (“Example 11”) further to any of the preceding Examples, the composite cover is coupled to an outside surface of the core member.

According to another example (“Example 12”) further to any of the preceding Examples, the acoustic ear fitting is conformable to a shape of a user's ear.

According to another example (“Example 13”) further to any of the preceding Examples, the porous fluoropolymer membrane includes expanded polytetrafluoroethylene.

According to another example (“Example 14”) further to any of the preceding Examples, the acoustic ear fitting further includes a biometric sensor, wherein the composite cover is interposed between the biometric sensor and the user's skin.

According to another example (“Example 15”) further to Example 14, the biometric sensor is an optical biometric sensor.

According to another example (“Example 16”) further to Example 14, the biosensor is a bioelectric biometric sensor.

According to another example (“Example 17”) an acoustic ear fitting includes a compliant scaffold, and an air permeable membrane coupled to the compliant scaffold, the air permeable membrane being comprised of a plurality of porous fluoropolymer layers including a porous fluoropolymer layer having a microstructure including a fold and an elastomer applied to the air permeable membrane such that the elastomer encapsulates a portion of the fold in the microstructure.

According to another example (“Example 18”) further to Example 17, the elastomer operates to maintain the fold in the absence of an eternal force being applied to deform the fold.

According to another example (“Example 19”) further to any of Examples 17 or 18, air is permitted to flow through channels within the microstructure of the plurality of porous fluoropolymer layers.

According to another example (“Example 20”) further to any of Examples 17 to 19, the air permeable membrane is vapor permeable.

According to another example (“Example 21”) further to any of Examples 17 to 20, the air permeable membrane is liquid impermeable.

According to another example (“Example 22”) further to any of Examples 17 to 21, wherein the fluoropolymer is expanded polytetrafluoroethylene.

According to another example (“Example 23”) a method of forming an acoustic ear fitting includes applying an elastomer to a portion of less than all of a structured porous fluoropolymer membrane to form a composite cover, the structured porous fluoropolymer membrane having a microstructure including a fold, the elastomer being applied to the structured porous fluoropolymer membrane such that the elastomer encapsulates a portion of the fold in the microstructure, the composite cover being air permeable, and stretching the composite cover over a core member such that the composite cover is elastically tensioned about the core member.

According to another example (“Example 24”) a method of forming an acoustic ear fitting includes applying an elastomer to a portion of less than all of a structured porous fluoropolymer membrane to from a composite cover, the structured porous fluoropolymer membrane having a microstructure including a fold, the elastomer being applied to the structured porous fluoropolymer membrane such that the elastomer encapsulates a portion of the fold in the microstructure, the composite cover being air permeable, preforming the composite cover such that the composite cover adopts a designated shape when supported, the preformed composite cover including a void, and injecting a core material into the void such that the core material stretches and supports the composite cover in the designated shape.

While multiple embodiments are disclosed, still other embodiments will become apparent to those skilled in the art from the following detailed description, which shows and describes illustrative examples. Accordingly, the drawings and detailed description are to be regarded as illustrative in nature and not restrictive.

### BRIEF DESCRIPTION OF THE DRAWINGS

The accompanying drawings are included to provide a further understanding of inventive embodiments of the disclosure and are incorporated in and constitute a part of this specification, illustrate examples, and together with the description serve to explain inventive principles of the disclosure.

FIG. 1 is an illustration of an acoustic energy delivery system consistent with various aspects of the present disclosure.

FIG. 2A is an image (top view) illustrating the structure of a thin structured membrane consistent with various aspects of the present disclosure.

FIG. 2B is an image (top view) illustrating the structure of the thin structured membrane after undergoing a structuring or conditioning process to add folds or wrinkles to the thin structured membrane consistent with various aspects of the present disclosure.

FIG. 2C is an image (top view) illustrating the structure of the thin structure membrane after having an elastomer applied to one or more portions thereof consistent with various aspects of the present disclosure.

FIG. 3A is an illustration of a composite cover consistent with various aspects of the present disclosure.

FIG. 3B is an illustration of a composite cover consistent with various aspects of the present disclosure.

FIG. 4A is a cross sectional view of a composite structure in a relaxed, unstretched state consistent with various aspects of the present disclosure.

FIG. 4B is a cross sectional view of the composite structure of FIG. 4A in a stretched state consistent with various aspects of the present disclosure.

FIG. 5 is an illustration of a composite cover consistent with various aspects of the present disclosure.

FIG. 6A is an illustration of a core member consistent with various aspects of the present disclosure.

FIG. 6B is a cross sectional view of the core member of FIG. 6A taken along line 6B-6B consistent with various aspects of the present disclosure.

FIG. 7A is an illustration of an acoustic energy delivery system consistent with various aspects of the present disclosure.

FIG. 7B is an illustration of an acoustic energy delivery system consistent with various aspects of the present disclosure.

FIGS. 8A and 8B illustrate a universal system for use with generic ear fittings consistent with various aspects of the present disclosure.

### DETAILED DESCRIPTION

Persons skilled in the art will readily appreciate that the various embodiments of the inventive concepts provided in the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

The present disclosure relates to systems configured to deliver acoustic energy to an ear canal of a user. More specifically, the present disclosure relates to compliant acoustic ear fittings used in accordance with acoustic systems that offer improved acoustic performance when compared to other conventional acoustic fittings while promoting breathability within the ear canal and isolating vulnerable electronic components from certain aspects of the outside environment.

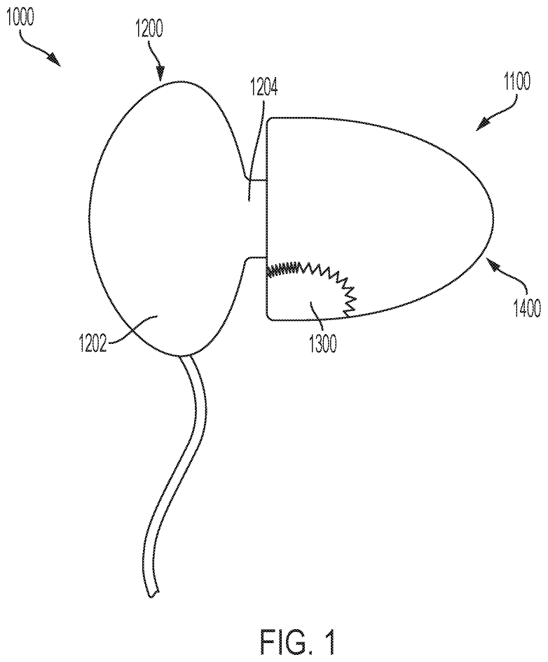

An acoustic system 1000 according to some embodiments is illustrated in FIG. 1. The acoustic system 1000 includes a compliant acoustic ear fitting 1100 coupled to an acoustic energy delivery apparatus 1200. In some examples, the compliant acoustic ear fitting 1100 includes a cover 1400 disposed about a portion of a core member 1300. As discussed in greater detail below, in some examples, the acoustic energy delivery apparatus 1200 includes a base 1202 and a mounting portion 1204. In some examples, the mounting portion 1204 of the acoustic energy delivery apparatus 1200 is configured to interface with the compliant acoustic ear fitting 1100. In some examples, the compliant acoustic ear fitting 1100 is configured to mount to the mounting portion 1204. In some examples, the mounting portion 1204 is received within an interior lumen of the compliant acoustic ear fitting 1100.

Thus, in various examples, the compliant acoustic ear fitting 1100 is coupleable to the acoustic energy delivery apparatus 1200. As shown in FIG. 1, the compliant acoustic ear fitting 1100 is mounted on the mounting portion 1204 of the acoustic energy delivery apparatus 1200. In some examples, the compliant acoustic ear fitting 1100 is removably mounted on a mounting portion of the acoustic energy delivery apparatus 1200 such that the compliant acoustic ear fitting 1100 can be selectively removed from the acoustic energy delivery apparatus 1200. Such a configuration provides for replacement or cleaning of the compliant acoustic ear fitting 1100, for example, without compromising the electronic components of the acoustic energy delivery apparatus 1200. In some other examples, the compliant acoustic ear fitting 1100 is permanently mounted on the mounting portion 1204 of the acoustic energy delivery apparatus 1200. The acoustic energy delivery apparatus 1200 may be an electro acoustic or other transducer configured to generate acoustic energy as those of skill in the art should appreciate.

As mentioned above, in some embodiments, the compliant acoustic ear fitting 1100 includes a core member 1300 and a cover 1400 disposed about the core member 1300. The core member 1300 can help provide structural support to the cover 1400. In various examples, the cover 1400 is generally formed as a thin structured membrane or film with an elastomer coating applied to one or more portions thereof. As discussed in greater detail below, such a configuration provides for a resilient composite cover that can conform to a user's ear canal. In some examples, the resilient composite cover is operable to allow air to pass therethrough while remaining impermeable to water or other liquids. In some examples, the resilient composite cover is impermeable to water or other liquids under normal operating conditions (e.g., during natural use and/or storage). Such a configuration can help optimize acoustic performance without compromising the electronic components of the acoustic energy delivery apparatus 1200.

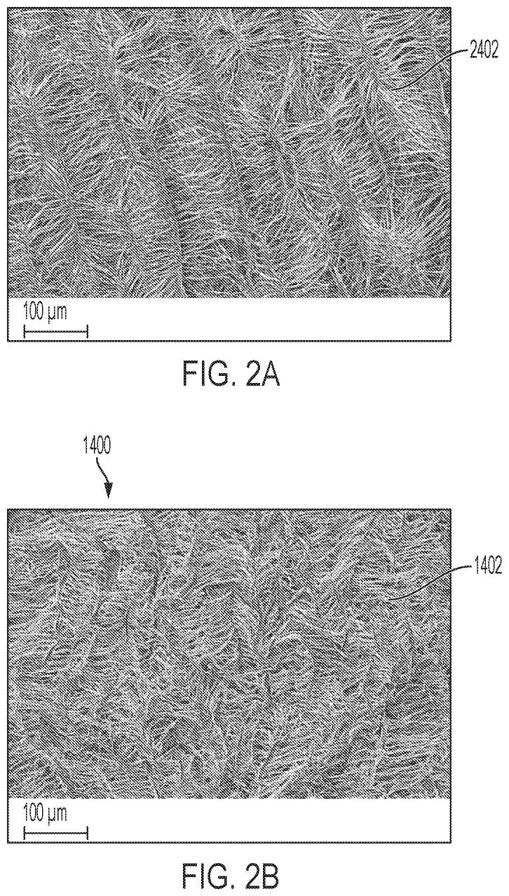

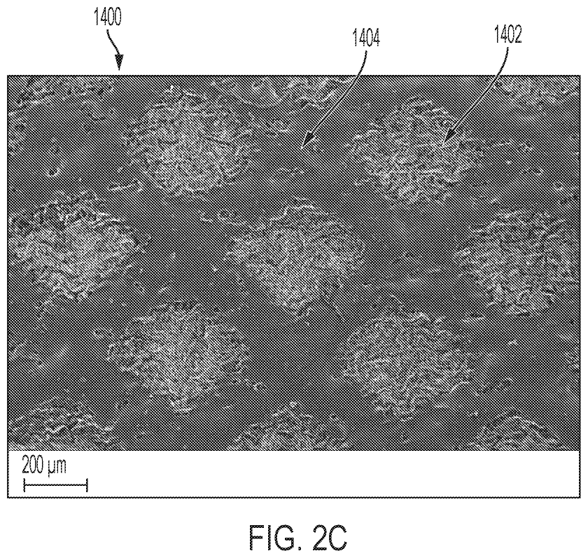

Turning now to FIGS. 2A-2C, a microstructure of the cover 1400 is illustrated. FIG. 2A illustrates the microstructure of the thin structured membrane 1402 prior to conditioning or structuring. In various examples, the thin structured membrane 1402 is formed of expanded polytetrafluoroethylene (ePTFE). However, other polymers may be used, including, but not limited to polyurethane, polysulfone, polyvinylidene fluorine (PVDF), perfluoroalkoxy polymer (PFA), polyolefin, fluorinated ethylene propylene (FEP), acrylic copolymers and polytetrafluoroethylene (PTFE).

FIG. 2B illustrates the microstructure of the thin structured membrane 1402 after it undergoes one or more conditioning or structuring processes. Examples of such thin structured membranes and the processes for making the same are illustrated and described in U.S. Patent Application Publication Number 2016/0167291, Ser. No. 14/907,668, filed Aug. 21, 2014, the entire contents of which are incorporated herein by reference. Thus, in various examples, the thin structured membrane 1402 illustrated in FIG. 2B is one that is preconditioned to have a microstructure (e.g., wrinkles, folds, or other geometric out-of-plane structures). In some examples, as explained in U.S. Patent Application Publication Number 2016/0167291, such a microstructure is achievable through the relaxing of a stretched elastic substrate having a thin unstructured membrane loaded thereon. Generally, this relaxing of the stretched elastic substrate causes one or more portions of the thin unstructured membrane 2402 (FIG. 2A) to wrinkle or fold, thereby forming the thin structured membrane 1402 (FIG. 2B). In some embodiments, the thin structured membrane 1402 is more moldable than the unstructured membrane. For instance, the microstructure is one that can be stretched as discussed in greater detail.

In some embodiments, the cover 1400 is formed as a composite. For example, FIG. 2C shows an elastomeric material applied to one or more portions of the thin structured membrane 1402 to form a cover 1400 having one or composite sections or portions 1404. In some examples, these composite sections or portions 1404 of the cover 1400 are imbibed or coated with an elastomer. In some examples, the incorporation of such a coating also improves durability of the cover.

In some examples, the elastomer may be silicone, fluorinated ethylene propylene (FEP), polyethylene terephthalate (PET), polyurethane, thermoplastic elastomers, or some other suitable fluoropolymer. In some examples, the elastomer may be applied to the thin structured membrane 1402 through lamination, imbibing, slot die coating, and one or more screen printing or gravure printing processes or techniques, as those of skill in the art will appreciate. In some embodiments, the composite cover 1400 is more elastic than the thin structured membrane 1402. Thus, in some embodiments, the composite cover 1400 is both moldable and elastic. In some examples, a first portion of the composite cover 1400 (such as a composite portion) is elastic while a second portion of the composite cover 1400 (such as an uncoated portion of the thin structured membrane 1402) is moldable.

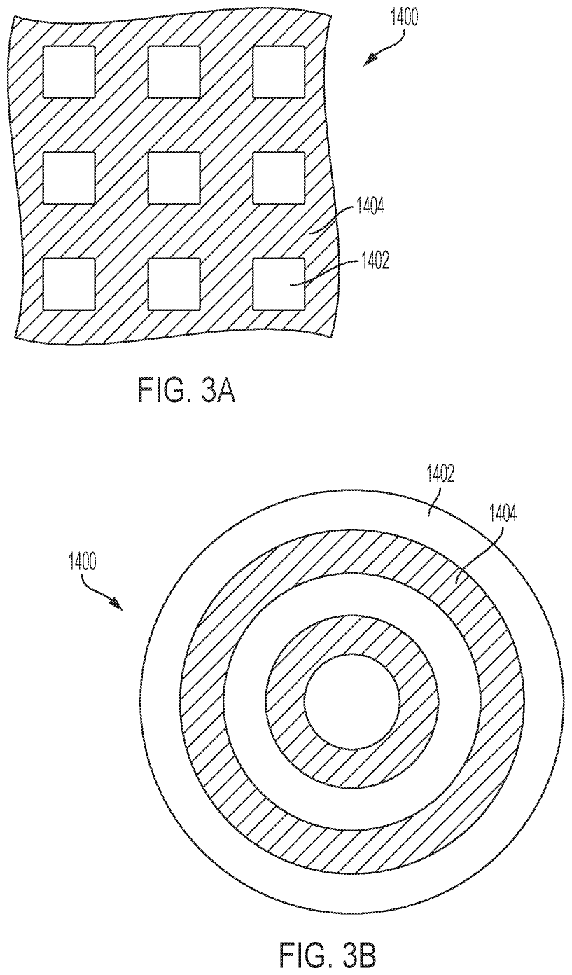

In some examples, the elastomer is applied to one or more portions or sections of the thin structured membrane 1402 in a predetermined pattern, such as the octothorpic pattern illustrated in FIG. 3A. As shown, the elastomer is applied to the thin structured membrane 1402 such that the composite sections 1404 extend laterally and longitudinally across the cover 1400. In some other examples, however, the elastomer may alternatively be applied to the thin structured membrane 1402 such that the composite sections 1404 extend in only one direction (e.g., only laterally, or only longitudinally, or only diagonally), or alternatively in 3 or more different directions (e.g., laterally, longitudinally, diagonally, concentrically, etc.). Likewise, the elastomer may be applied to the thin structured membrane 1402 in a variety of other patterns without departing from the spirit or scope of the disclosure.

For example, as illustrated in FIG. 3B, the elastomer may be applied to the thin structured membrane 1402 in one or more concentric ring patterns. As shown, the elastomer is applied such that the composite portions 1404 and the uncoated thin structured membrane portions form alternating concentric rings. While the alternating concentric rings illustrated in FIG. 3B are generally of equal thickness, it should be appreciated that the alternating concentric rings may vary in thickness (either progressively or randomly).

In some other examples, the elastomer may be applied to one or more portions or sections of the thin structured membrane 1402 in a randomized pattern. In yet some other examples, the elastomer may be applied to one or more first portions of the thin structured membrane 1402 in a predetermined pattern while the elastomer is applied to one or more second portions of the thin structured membrane 1402 in a randomized pattern. Thus, in some examples, the cover 1400 may include a plurality of different composite portions each having different material properties (e.g., resiliency, porosity, acoustic transparency, etc.).

In various examples, these different elastomer coating configurations can be selected and tuned to optimize the stretching performance of the cover 1400 in different directions. For instance, in some examples, the cover 1400 may be tuned to resiliently deform when subjected to uniaxial stretching, while in other instances the cover 1400 may be tuned to resiliently deform when stretched biaxially, radially, or in three or more directions. The composite covers 1400 discussed herein are thus versatile in that they may be constructed to resiliently deform in one or more designated directions without tearing, breaking, or otherwise plastically deforming.

As mentioned above, in some examples, by forming a composite cover 1400 that includes one or more composite sections 1404 and one or more uncoated, thin structured membrane sections, the cover 1400 can be formed such that different portions of the cover 1400 are associated with different material properties. For example, certain areas or sections of the cover 1400 may be more resilient or elastic than other areas or sections of the cover 1400. Similarly, certain areas or sections of the cover 1400 may have differing degrees of permeability or porosity than other areas or sections of the cover 1400. In some examples, the elastomer can be applied to the thin structured membrane 1402 such that the cover 1400 is acoustically transparent to (or alternatively acoustically enhances) the acoustic energy output by the acoustic energy delivery apparatus 1200.

For instance, in various examples, the thin structured membrane 1402 vibrates in response to the acoustic signal generated by the acoustic energy delivery apparatus 1200. In some examples, the thin structured membrane 1402 is configured to vibrate more (or resonate) at one or more designated frequencies within the human hearing frequency spectrum. In some such examples, this increased vibration is associated with an enhancement of the acoustic signal generated by the acoustic energy delivery apparatus 1200. Thus, in some examples, the thin structured membrane 1402 enhances the energy output across one or more discrete frequency ranges (or sub frequency ranges) with a maximum vibrational response within each sub frequency range occurring at a corresponding resonant frequency within such frequency range, as those of skill should appreciate. In some such examples, such vibration causes an increase in gain of the acoustic signal generated by the acoustic energy delivery apparatus 1200.

In some examples, the thin structured membrane 1402 is additionally or alternatively configured to attenuate the energy output by the acoustic energy delivery apparatus 1200 at one or more designated frequencies within the human hearing frequency spectrum, as those of skill should appreciate. That is, in some examples, the thin structured membrane 1402 has absorptive properties that cause attenuation of the acoustic signal generated by the acoustic energy delivery apparatus 1200 at one or more designated frequencies. In some examples, the thin structured membrane 1402 has absorptive properties that additionally or alternatively cause attenuation of ambient noise (e.g., across one or more frequency ranges that are not otherwise associated with or do not otherwise correspond with expected frequency outputs of the acoustic energy delivery apparatus 1200). Thus, in various examples, the thin structured membrane 1402 is designed to possess vibrational modes that enhance/attenuate energy at designated frequencies.

In some examples, in addition or alternative to enhancement and/or attenuation, the thin structured membrane 1402 is acoustically transparent to the energy output by the acoustic energy delivery apparatus 1200 across one or more frequency ranges within the human hearing frequency spectrum. That is, in various examples, the thin structured membrane 1402 has a minimal effect on the energy or the signal output by the acoustic energy delivery apparatus 1200. In some examples, such a minimal effect is not otherwise detectable by the human ear.

In some examples, the microstructure of the thin structured membrane 1402 includes one or more nodes and one or more fibrils extending from the one or more nodes as those of skill in the art should appreciate. While the fibrils generally terminate into the nodes, the fibrils are separated from one another by a gap or space. In some examples, structure of such gaps or spaces separating the fibrils act as voids, channels, or conduits. In some examples, these structures cause attenuation of acoustic signals though various losses (e.g., viscous, mechanical, thermal, etc.). In other examples, air passes through these structures resulting in minimal energy loss. Those of skill in the art should appreciate that the degree of permeability through a given layer of the thin structured membrane 1402 is a function of at least the relative spacing between nodes and the size, frequency, and alignment of the conduits or channels.

Likewise, those of skill in the art should appreciate that the composite cover 1400 may also include multiple thin structured membrane layers. In some examples, these layers of the thin structured membrane 1402 may be oriented relative to one another to optimize air permeability, which in turn may optimize acoustic performance (e.g., acoustic transparency, or acoustic enhancement). For example, a first layer may be oriented relative to a second layer such that the fibrils of the first layer generally extend perpendicular to (or are otherwise angled relative to) the fibrils of the second layer. In some examples, however, in lieu of attempting to achieve specific relative orientations between layers, additional layers are added until a desired performance is achieved (e.g., air flow, permeability, acoustic transparency, acoustic enhancement, etc.). In some examples, one or more of the layers are coupled together (e.g., by way of bonding, adhesion, etc.).

As discussed above, in some examples, an elastomer is applied to one or more portions of the thin structured membrane 1402 to create one or more composite sections 1404. In some examples, the thin structured membrane 1402 imbibes the elastomer such that the elastomer fills or otherwise occupies one or more of the gaps between fibrils in the region of the thin structured membrane 1402 where the elastomer is applied. Thus, in some examples, one or more of the channels or conduits between the fibrils are filled or otherwise blocked by the elastomer such that air is obstructed from passing therethrough. Accordingly, the composite cover 1400 can be configured such that different regions of the cover 1400 have different performance characteristics (e.g., air flow, permeability, acoustic transparency, acoustic enhancement, etc.).

In some examples, the application of the elastomer to one or more portions or sections of the thin structured membrane 1402 results in a resilient composite cover 1400 (or at least a cover that is more resilient than a cover without composite sections 1404). In such examples, the cover 1400 can generally be stretched in one or more directions without undergoing plastic deformation. Specifically, as mentioned above, after the thin structured membrane 1402 is conditioned or structured (e.g., one or more wrinkles or folds are formed therein) the elastomer is applied to one or more portions or sections of the thin structured membrane 1402 to form one or more composite portions 1404 (i.e., portions or sections including both thin structured membrane material coated and/or imbibed with elastomer material).

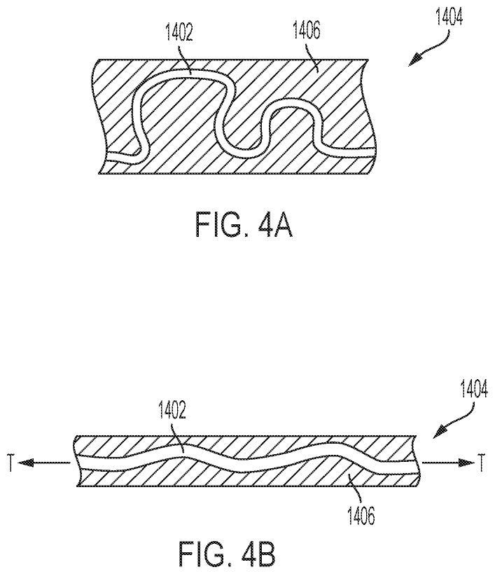

Turning now to FIGS. 4A and 4B, in some examples, the elastomer operates to maintain the microstructure (i.e., structures, folds, wrinkles, etc.) of the composite sections 1404 in response to a deformation of the composite sections 1404. Specifically, in some examples, the elastomer encapsulates one or more of the fibrils (which are folded or wrinkled) and operates to maintain the structure and orientation of the fibril. Thus, where a folded or wrinkled fibril section is stretched or otherwise deformed, the elastomer encapsulating the folded or wrinkled fold section operates to maintain the fold or wrinkle of the fibril section by restoring the stretched or deformed fibril section to its folded or wrinkled configuration after the force or strain causing the deformation is removed. FIG. 4A illustrates a cross sectional view of a portion of a composite section 1404 including a thin structured membrane 1402 and an elastomer 1406. The composite section 1404 in FIG. 4A is in an undeformed or unstretched configuration (e.g., not under tension). As shown, the fibril of the thin structured membrane 1402 is encapsulated by the elastomer 1406.

In various examples, as tension is applied to the cover 1400, the cover 1400 stretches or otherwise deforms. Specifically, as shown in FIG. 4B, when tension is applied, the fibrils of the thin structured membrane 1402 tend to straighten. In some examples, this stretching of the cover 1400 is associated with the stretching of the composite portions 1404 and/or the stretching of the uncoated sections of the thin structured membrane 1402. Thus, as those of skill will appreciate, as the composite portions 1404 stretch or deform, the structures (e.g., folds or wrinkles of the fibrils) making up the microstructure of the composite portions 1404 straighten (i.e., the folds partially or completely unfold; the wrinkles partially or completely unwrinkle). In some examples, this stretching of the elastomer causes the elastomer to store energy (e.g., potential energy).

As tension is removed, the elastomer in the composite portions 1404 converts the stored potential energy to kinetic energy which operates influence the deformed elastomer and deformed microstructure of the thin structured membrane 1402 to return to an undeformed state (e.g., the fibrils return to a folded or wrinkled configuration). That is, as tension is removed, the elastomer operates to restore the microstructure (i.e., structures, folds or wrinkles) of the thin structured membrane 1402 of the composite sections 1404.

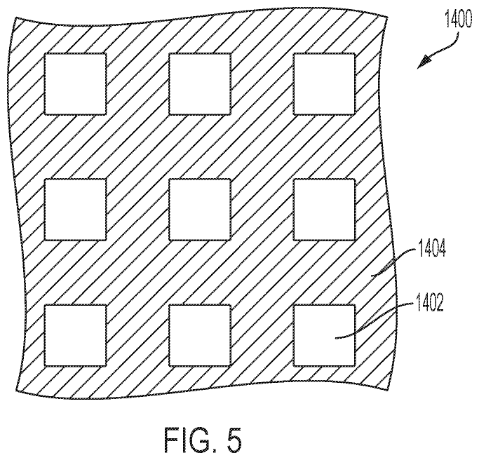

In some examples, the elastomer additionally operates to maintain or restore an otherwise deformed microstructure (i.e., structures, folds or wrinkles) of those portions of the structured membrane material to which the elastomer is not applied (i.e., the uncoated or unimbibed portions of the cover 1400). For instance, and with reference now to FIG. 5, in some examples, one or more of the uncoated sections or portions of the thin structured membrane 1402 are enveloped or otherwise bordered on one or more sides by a composite section 1404 (i.e., a section coated or imbibed with elastomer). As explained above, as the cover 1400 is stretched, the structures (e.g., folds or wrinkles) making up the microstructure of the composite portions 1404 straighten. In some examples, the structures (e.g., folds or wrinkles) making up the microstructure of the uncoated portions of the thin structured membrane 1402 additionally straighten.

As tension is removed from the cover 1400, the energy stored in the elastomer of the composite sections 1404 causes the microstructure to return to its undeformed state (e.g., folded or wrinkled). In some examples, as the composite sections 1404 transition toward their undeformed states, force is also exerted on the deformed uncoated sections or portions of the thin structured membrane 1402 to which they border. The forces exerted on the deformed uncoated sections or portions of the thin structured membrane 1402 influence the deformed uncoated sections or portions of the thin structured membrane 1402 to return to (or to partially return to) their undeformed structured states. That is, in some examples, the elastomer and/or the composite portions of the composite cover 1400 operate to restore the microstructure of the coated and uncoated portions of the thin structured membrane 1402 after external forces are removed.

As mentioned above, in some examples, certain areas or sections of the cover 1400 may have differing degrees of permeability or porosity than other areas or sections of the cover 1400. For instance, in some examples, the composite sections 1404 of the cover 1400 are generally associated with a differing degree of porosity or permeability than are the uncoated sections of the cover 1400. In some such examples, the thin structured membrane 1402 is breathable in that the thin structured membrane 1402 permits a degree of airflow therethrough while the elastomer and/or composite sections 1404 are generally non-breathable or non-porous (or are less breathable or less porous). In some examples, both the thin structured membrane 1402 and the composite sections 1404 are liquid impermeable (but may be vapor permeable).

In some examples, the cover 1400 (e.g., including the coated and uncoated portions of the cover) permits a degree of air flow in the range of fifteen (15) to one hundred (100) Frazier. It should be appreciated that the degree of airflow depends, at least in part, on the material coating and its thickness, as well as the pattern. Thus, these features can be manipulated to specifically tailor the performance of the system.

In various examples, the water entry pressure (WEP) of the membrane determines its ability to resist liquid entry. For instance, in some examples, the higher the water entry pressure of the membrane the more resistive the membrane is to water entry. Generally, liquids with lower surface energies than water (e.g., sweat/sebum mixtures) have lower entry pressures than water (commonly referred to as “Liquid Entry Pressure” or LEP). Airflow generally inversely tracks with WEP and LEP but other factors such as material thickness may impact airflow performance. In some examples, WEP and LEP are largely determined by pore size distribution and material chemistry. In various examples, higher airflow measures are generally associated with higher acoustic transparency in the lower human hearing frequency ranges. Thus, higher Frazier value ranges are generally associated with higher acoustic transparency.

In various examples, the pattern, density, and ratio of elastomer to thin structured membrane material is selected to provide adequate exchange of air (or airflow through the cover) and acoustic energy for user comfort and acoustic performance. In some examples, the air permeability of the cover 1400 is less than the air permeability of the thin structured membrane 1402. In other words, the air permeability of the cover 1400 is less than it would otherwise be if no elastomer were applied to the thin structured membrane 1402.

As mentioned above, in some examples, the cover 1400 can be configured such that it is acoustically transparent to the acoustic energy output by the acoustic energy delivery apparatus 1200. That is, the cover 1400 can be utilized to protect the electrical components of the acoustic energy delivery apparatus 1200 (e.g., water impermeable) without significantly compromising performance of the acoustic energy delivery apparatus 1200 (e.g., air permeable). In some examples, acoustic transparency is considered where there exists a less than two decibel (<2 dB) degradation of frequency response of an acoustic system with the cover 1400 applied when compared with the system without the cover 1400 applied. In other examples, acoustic transparency is considered where there exists a less than three decibel (<3 dB) degradation of frequency response of an acoustic system with the cover 1400 applied when compared with the system without the cover 1400 applied. In some examples, the acoustic transparency considerations depend on the frequency band, as those of skill in the art will appreciate.

In some examples, the cover 1400 and/or the core 1300 may additionally or alternatively operate to enhance the acoustic performance of the acoustic energy delivery apparatus 1200. In some examples, the cover 1400 and/or the core 1300 may operate to reduce, minimize, or eliminate ambient noise from the surrounding environment from entering the user's ear canal, the presence of which may otherwise degrade the acoustic performance of the acoustic energy delivery apparatus 1200. Thus, in some examples, the cover 1400 and/or the core 1300 operate to isolate ambient noise from entering the ear canal and degrading the acoustic performance of the acoustic energy delivery apparatus 1200. In some examples, the cover 1400 and/or the core 1300 may additionally or alternatively operate to reduce, minimize, or eliminate reverberation of acoustic signals propagating through the ear canal, such as by absorbing certain frequencies of acoustic energy, for example.

In some examples, the elastomer is applied to both sides of the thin structured membrane 1402. In other examples, the elastomer is applied to only one side of the thin structured membrane 1402. In some such examples, as explained in greater detail below, in addition to contributing to the resiliency of the cover 1400, the elastomer facilitates frictional retention of the cover 1400 on the core member 1300. In addition, by applying the elastomer to only a single side of the thin structured membrane 1402, the non-coated side can maintain a soft and compliant feel and texture, which makes the compliant acoustic ear fitting 1100 comfortable to wear or place in the ear canal.

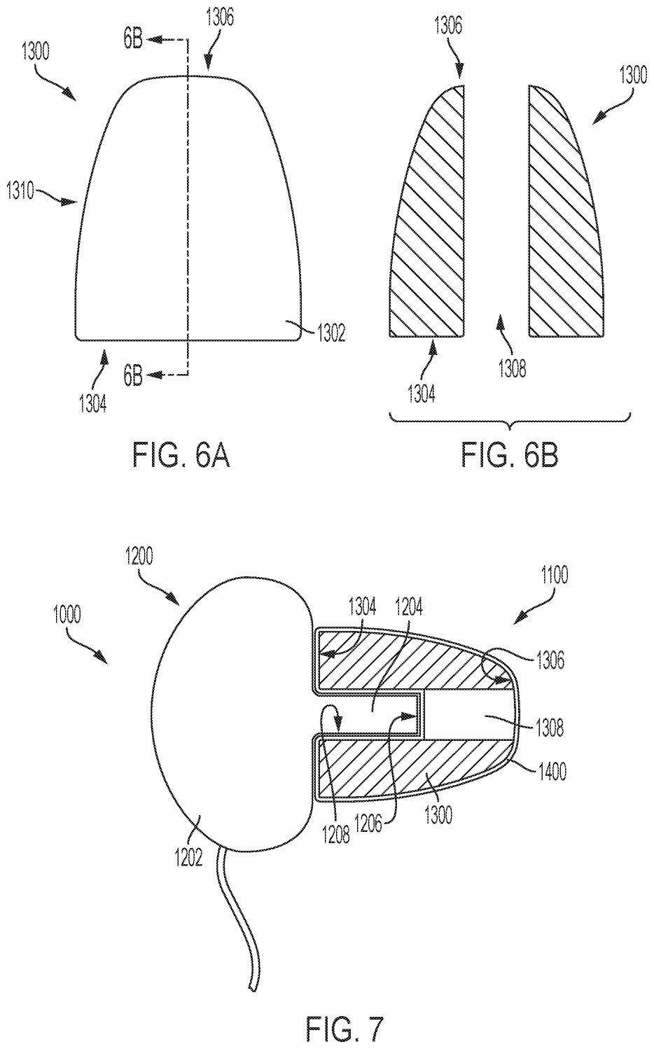

As discussed above, in various examples, the compliant acoustic ear fitting 1100 generally includes a cover 1400 and a core member 1300 (e.g., core member 1300, FIG. 1). Turning now to FIGS. 6A and 6B, a core member 1300 is illustrated. FIG. 6B is a cross sectional view of the core member 1300 taken along line 6B-6B of FIG. 6A. In some examples, the core member 1300 includes a body 1302, a bottom 1304 and a top 1306. In some examples, one or more lumens, such as lumen 1308 extend through the body 1302 of the core member 1300. In some examples, the lumen 1308 operates as a conduit through which acoustic energy is delivered to the ear canal, as discussed in greater detail below. In some examples, the lumen has a circular cross-section. However, it should be appreciated that the lumen may have an ovular, polygonal, or any other cross-section without departing from the spirit or scope of the application. In some examples, the core member 1300 further includes an exterior circumferential face 1310 situated between the bottom 1304 and the top 1306 of the core member 1300.

In some examples, the top 1306 of the core member 1300 faces toward an interior of the ear canal and the bottom 1304 of the core member 1300 faces toward an exterior of the ear canal. In some examples, the body 1302 of the core member 1300 is generally shaped to conform to the ear canal. In some examples, the body 1302 may be entirely comprised of resilient foam or other elastomeric material(s), or may include elastomeric portions, which help the body 1302 to conform to the ear canal. In some examples, the body 1302 may be constructed of resilient soft elastomeric materials, such as silicone rubber or any other soft polymer. In some examples, the body 1302 may alternatively or additionally include or may be constructed entirely of compressible foam such as polyurethane or polyvinylchloride. The body 1302 may be formed by methods known in the art (e.g., injection molding or other suitable manufacturing processes) and may take any shape including dome, fluted, conical, frustoconical, star, bulbous, or another desirable shape.

The cover 1400 may be attached or coupled to the core 1300 by any known attachment methods including, but not limited to adhesives, thermal bonding, or molding. In some examples, the elastomer may facilitate such bonding. As mentioned above, in some examples, the core 1300 provides a scaffold for (or otherwise supports) the cover 1400. In some examples, the core 1300 is formed independent of the cover 1400, such as through one or more molding or forming processes.

In such examples, after forming the core 1300, the cover 1400 is stretched over and coupled to the core 1300. The cover 1400 may be attached to the core 1300 by any known attachment means including adhesives, thermal bonding, etc. as discussed above. For instance, in some examples, an adhesive may be applied to the core 1300 prior to the cover 1400 being stretched thereover. In some other examples, adhesive may additionally or alternatively be applied to the cover 1400 prior to stretching the cover 1400 over the core member 1300. In some examples, as mentioned above, the elastomer may facilitate bonding. That is, in some example, in lieu of another adhesive, the elastomer applied to the thin structured membrane 1402 may additionally function as an adhering agent for coupling the cover 1400 to the core 1300.

In some examples, the cover 1400 is coupled to the core 1300 such that the portion of the cover 1400 extending across the lumen of the core 1300 is entirely free of elastomer. That is, in some examples, the cover 1400 is coupled to the core 1300 such that the composite portions thereof are not exposed to the lumen of the core 1300. In some other examples, the cover 1400 is coupled to the core 1300 such that a designated proportion of the area of the lumen is covered by composite portions 1404 of the cover 1400. That is, in some examples, it is desirable to obstruct a portion of the lumen with elastomer. A reduction in acoustic signal or change in spectrum can occur as a result of blockage, a change in acoustic vibrational modes of the membrane (which may occur as a result of a change in mass, thickness, and/or other material properties like stiffness, and mounting of the cover 1400). Thus, permissible ranges depend at least on the design of the membrane and how it is mounted.

In some examples, the compliant acoustic ear fitting is formed by preforming/shaping the cover such that the cover adopts a desired geometry or shape when supported by a core, and injecting a core material (see above) into the preformed/shaped cover such that the core material expands and supports the cover in the desired geometry or shape. In some examples, the cover is preformed such that it forms a void that the core material can be injected into. For example, the cover may be preformed in a shape of the compliant acoustic ear fitting such that when the core material is injected into the void, the core material expands the cover and causes the cover to adopt the preformed shape. In some examples, the cover is preformed with a continuous exterior surface and a hollow interior. In some such examples, the core material is injected into the hollow interior. In some examples, the cover is compliant and unable to maintain the preformed shape without support from the core member.

In some examples, the core material solidifies or hardens with the cover 1400 disposed thereabout. In some examples, the inflation and expansion of the cover 1400 causes the cover 1400 to be elastically tensioned about the core material as the core material solidifies or hardens. That is, in some examples, instead of stretching the cover 1400 over an already preformed core 1300, the core 1300 is formed inside of a preformed cover 1400 such that as the core material sets-up (e.g., expands, solidifies, hardens, etc.), the cover 1400 stretches and becomes coupled to the core 1300. In these examples, the expansion/injection of the core material is the mechanism causing the stretching of the cover 1400. Those of skill in the art should appreciate that, in such examples, the cover 1400 is preformed or preconfigured such that as the core material sets up and the cover 1400 becomes stretched thereabout, the compliant acoustic ear fitting 1100 adopts a desired shape and size. Those of skill in the art should also appreciate that acoustic properties of the system depend on these various different methods of mounting (with and without tension), as well with the selected material, as mentioned herein.

In some examples, as explained above, the elastomer applied to the thin structured membrane 1402 provides for a resilient composite cover 1400. In some examples, the elastomer additionally operates as a sealing mechanism to prevent unwanted contaminants from entering the acoustic energy delivery apparatus 1200. In some such examples, the elastomer forms a seal with the core 1300. In other such examples, the elastomer additionally or alternatively forms a seal with one or more portions of the acoustic energy delivery apparatus 1200.

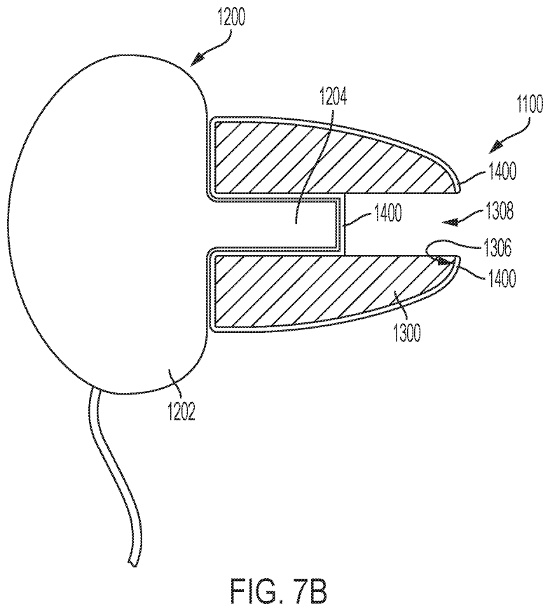

Turing now to FIG. 7A, an acoustic system 1000 is illustrated as including a compliant acoustic ear fitting 1100 and an acoustic energy delivery apparatus 1200. The compliant acoustic ear fitting 1100 includes a core 1300 and a cover 1400 disposed about the core 1300. In some examples, the mounting portion 1204 of the acoustic energy delivery apparatus 1200 is received by the compliant acoustic ear fitting 1100. Specifically, an end 1206 of the mounting portion 1204 is inserted into the lumen 1308 of the core 1300. In some examples, the portion of the cover 1400 that would otherwise extend across the lumen 1308 along the bottom 1304 of the core 1300 is deflected and stretched over the mounting portion 1204 of the acoustic energy delivery apparatus 1200 as the mounting portion 1204 of the acoustic energy delivery apparatus 1200 extends into the lumen 1308. Accordingly, the portion of the cover 1400 that is stretched over the end 1206 of the mounting portion 1204 of the acoustic energy delivery apparatus 1200 operates to obstruct contaminants such as water from entering the acoustic energy delivery apparatus 1200 through the mounting portion 1204.

In some such examples, the cover 1400 forms a seal against the mounting portion 1204. In some examples, the seal is formed by one or more portions of the elastomer applied to the thin structured membrane 1402 that contacts the mounting portion 1204. For example, in instances where the elastomer is applied to the thin structured membrane 1402 in one or more alternating concentric rings (see FIG. 3B) and the cover 1400 is coupled to the core 1300 such that the alternating concentric rings are coaxial with the core 1300, a ring of elastomer may form a circular peripheral seal where the elastomer ring contacts the mounting portion 1204 (e.g., about a peripheral surface 1208 of the mounting portion 1204). That is, in this and other examples, the elastomer applied to the thin structured membrane 1402 may be continuous about a surface with which it contacts in a manner that facilitates the formation of a seal. In some other examples, the seal is additionally or alternatively formed between one or more portions of the thin structured membrane 1402 that contacts the mounting portion 1204.

In some examples, the cover 1400 additionally or alternatively forms a seal against the core 1300 in a manner that obstructs outside contaminants from entering the lumen 1308 of the core 1300. In some examples, such seal is formed by one or more portions of the elastomer applied to the thin structured membrane 1402 that contacts the core 1300. For example, in instances where the elastomer is applied to the thin structured membrane 1402 in one or more alternating concentric rings (see FIG. 3B), a ring of elastomer may form a peripheral seal where the elastomer ring contacts the core 1300 (e.g., about a portion of the lumen 1308). In some other examples, the seal is additionally or alternatively formed between one or more portions of the thin structured membrane 1402 that contacts the mounting portion 1204. Although not illustrated, in some other examples, a seal may be additionally or alternatively formed between the base 1202 of the acoustic energy delivery apparatus 1200 and the core 1300 and/or the cover 1400.

While the compliant acoustic ear fitting 1100 illustrated in FIG. 7A is shown with the cover 1400 disposed about an entirety of the core 1300 (e.g., both ends of the lumen 1308 are covered by the cover 1400), in some examples, one or more portions of the core 1300 are exposed or otherwise not covered by the cover 1400. For example, the acoustic system of FIG. 7B is illustrated as including a compliant acoustic ear fitting 1100 wherein the cover 1400 does not extend across the entire top surface 1306 of the core 1300. Accordingly, a portion of the lumen 1308 is exposed or otherwise not concealed by the cover 1400. Nevertheless, as shown, the mounting portion 1204 of the acoustic energy delivery apparatus 1200 is covered by the cover 1400. It should be appreciated that such a configuration may be associated with an acoustic performance that differs from that of the configuration illustrated in FIG. 7A as a result of differing numbers of layers of the cover 1400 being situated between the ear canal and the acoustic energy delivery apparatus 1200.

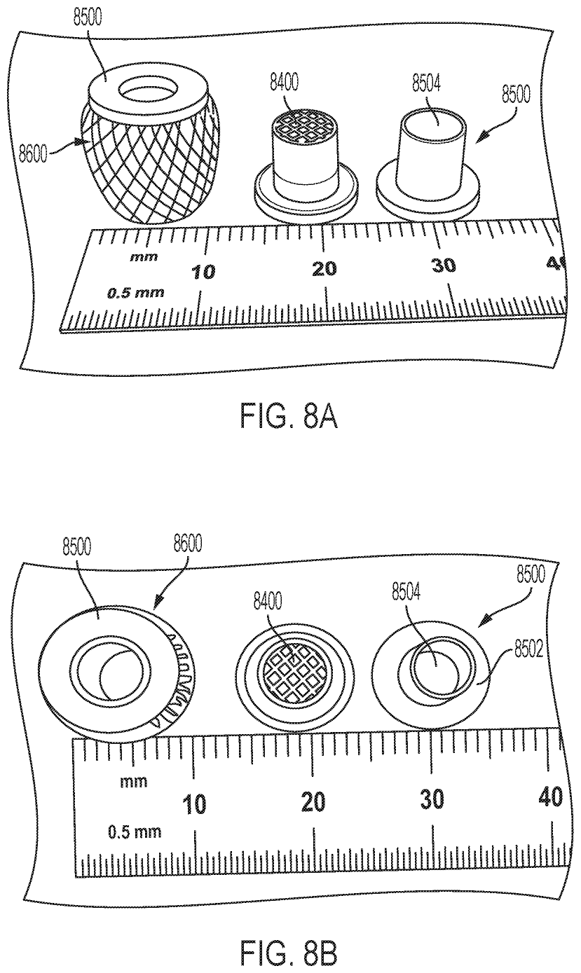

Turning now to FIGS. 8A and 8B, a breathable, water impermeable, universal sleeve 8500 for use with generic ear fittings 8600 is illustrated. Generally, the universal sleeve 8500 is insertable or otherwise coupleable with a variety of generic ear fittings, such as generic ear fitting 8600. In some examples, such a configuration provides that existing acoustic ear fitting products can be retrofitted with the universal sleeve 8500 and thus an acoustically transparent device that operates to isolate vulnerable electronic components from the surrounding environment.

In various examples, the universal sleeve 8500 is a structural component having a body 8502 and a lumen 8504 extending therethrough. In some examples, the universal sleeve 8500 is outfitted with a cover 8400 such that the cover 8400 extends over a portion of the lumen extending through the universal sleeve 8500. The cover 8400 may be attached or coupled to the universal sleeve 8500 by any known attachment methods including, but not limited to adhesives, thermal bonding, or molding. The cover 8400 is consistent with the various covers discussed herein in that it includes a thin structured membrane having elastomer applied to one or more portions thereof.

As shown in FIGS. 8A and 8B, the universal sleeve 8500 is configured to be received by a variety of different generic ear fittings, such as generic ear fitting 8600. In some examples, the universal sleeve 8500 is coupled to the generic ear fitting 8600 such that the universal sleeve 8500 operates to isolate vulnerable electronic components of an acoustic energy delivery apparatus from the surrounding environment when the universal sleeve 8500 and generic ear fitting 8600 are coupled thereto.

As mentioned above, in some examples, the cover is comprised of multiple layers of thin structured membrane. In various examples, the cover (or thin structured membrane or portions of the thin structured membrane free of elastomer) is configured to draw moisture out of the ear canal. In some examples, moisture drawn from the ear canal is in the form of liquid. In some examples, this liquid is a solution of water and sebum. In some examples, the material of the cover is configured to wick liquid from within the ear canal. In some example, wicking occurs through capillary action. In some examples, a first or inner layer (e.g., layer exposed to the inside of the ear canal) is more hydrophilic (or less hydrophobic) than is a second or outer layer (e.g., layer exposed to the outside environment). Those of skill should appreciate that configurations that draw moisture in the form of liquid out of the ear canal may be beneficial for disposable solutions, such as disposable earbuds or disposable earbud covers. In various examples, such configurations may incorporate a sweat diagnostics capability (e.g., single-use earbud/cover that enables listening to music while working-out while also getting real-time information on hydration status). In some examples, the cover is configured such that it can be separated from the acoustic energy delivery apparatus such that it can be cleaned (e.g., foreign bodies expelled therefrom) and reused.

Additionally or alternatively, in some examples, moisture drawn from the ear canal or that is otherwise free to pass through the cover (or thin structured membrane or portions of the thin structured membrane free of elastomer) is in the form of vapor. Thus, in some examples, while the cover is configured to draw or otherwise allow vapor to exit the ear canal, the cover does not absorb liquid. In some examples, the cover is configured to repel liquid. In some examples, the cover is oleophobic. In some examples, such configurations operate to minimize clogging of the microstructure of the cover with sebum or other microscopic materials in solution with water, which could have a detrimental impact on the acoustic performance of the cover.

In some examples, a multilayered construction additionally or alternatively provides a variety of acoustic benefits, as discussed above. For example, a multilayered construction may be utilized to optimize a degree of air flow that is permitted to permeate through the cover. In some other examples, a multilayered construction may be utilized to optimize reverberation characteristics of the cover.

As mentioned above, some configurations provide for replacement or cleaning of the compliant acoustic ear fitting. In some other examples, one or more antimicrobial agents (e.g., silver) may additionally or alternatively be applied to the cover. That is, in some examples, the cover and/or core member may be coated with an antimicrobial agent that operates to kill or slow the growth of microorganisms.

In various examples, the above-discussed cover and/or the compliant acoustic ear fitting is configured for used in combination with one or more biometric data gathering devices (e.g., devices configured for use in electroencephalography (EEG), electrocardiography (ECG), photoplethysmography (PPG), measuring heart rate (HR), oxygen consumption (VO2), total energy expenditure (TEE), chemical biomarker detection in sweat, temperature, etc.). In some examples, optical biometric sensors are used to measure blood flow, such as PPG. However, such optically-based sensors are notorious for motion sensitivity. Similar considerations concerning motion sensitivity are at play with sensing of bioelectric signals such as EEG and ECG. Consequently, locating the biometric sensor at or within the ear, where motion artifacts are generally less significant than in other potential locations (e.g., the wrist) affords greater accuracy during motion and exercise. Because the ear provides a means of closely coupling a biosensor to the skin in a stable, accessible location, biometric data gathering in the ear is a convenient platform for obtaining higher quality biometric data than those conventional systems mentioned above.

The cover and/or compliant acoustic ear fitting discussed herein provides a physiologically comfortable, stable interface between biosensors incorporated into an ear housing (e.g., an acoustic energy delivery apparatus that includes one or more biometric sensors) and a user's skin. Thus, in various examples, the cover and/or compliant acoustic ear fitting is configurable to overlay a sensing surface/device. In so doing, an interface is provided between the biosensor (interior to the ear housing) and the user's skin (exterior to the ear housing). In various examples, constituents of the cover are selected to provide spectral selectivity of the light wavelengths used in PPG applications while preserving a temperate, breathable, water-resistant skin interface. Similarly, in various examples, the acoustically transparent composite cover disclosed herein is additionally or alternatively rendered electrically conductive for use in overlaying bioelectric sensors, such as EEG and ECG, for providing a combination of electrical conductivity through a stable skin interface and physiological comfort. Additionally or alternatively, in some examples, the cover and/or compliant acoustic ear fitting is itself invested with biosensor capabilities, thereby providing one or more biometric sensing capabilities. For instance, in some examples, one or more biometric sensors can be laminated directly into the cover or molded into the compliant acoustic ear fitting. Those of skill should appreciated that locating the biosensor more proximate to the user's skin may provide higher quality biometric signals.

The inventive scope of this application has been described above both generically and with regard to specific examples. It will be apparent to those skilled in the art that various modifications and variations can be made in the examples without departing from the scope of the disclosure. Likewise, the various components discussed in the examples illustrated and described herein are combinable. Thus, it is intended that the examples cover the modifications and variations of the inventive scope.

1. An acoustic ear fitting comprising:
a core member; and
a composite cover coupled to the core member, the composite cover being permeable to air, the composite cover being comprised of a porous fluoropolymer membrane having a microstructure including a fold and an elastomer applied to a portion of less than all of the porous fluoropolymer membrane, the elastomer operating to restore the microstructure of the porous fluoropolymer membrane including the fold after a force causing a deformation of the porous fluoropolymer membrane is removed.

2. The acoustic ear fitting of claim 1, wherein the composite cover is acoustically transparent.

3. The acoustic ear fitting of claim 1, wherein the composite cover is acoustically enhancing.

4. The acoustic ear fitting of claim 2, wherein the composite cover operates to provide ambient noise isolation.

5. The acoustic ear fitting of claim 1, wherein moisture is free to pass through the composite cover and exit a user's ear canal.

6. The acoustic ear fitting of claim 1, wherein the composite cover is vapor permeable.

7. The acoustic ear fitting of claim 1, wherein the composite cover is liquid impermeable.

8. The acoustic ear fitting of claim 1, wherein the core member is comprised of a foam.

9. The acoustic ear fitting of claim 8, wherein the foam is elastomeric.

10. The acoustic ear fitting of claim 8, wherein the composite cover is mounted within the foam.

11. The acoustic ear fitting of claim 1, wherein the composite cover is coupled to an outside surface of the core member.

12. The acoustic ear fitting of claim 1, wherein the acoustic ear fitting is conformable to a shape of a user's ear.

13. The acoustic ear fitting of claim 1, wherein the porous fluoropolymer membrane includes expanded polytetrafluoroethylene.

14. The acoustic ear fitting of claim 1, further comprising a biometric sensor, wherein the composite cover is interposed between the biometric sensor and the user's skin.

15. The acoustic ear fitting of claim 14, wherein the biometric sensor is an optical biometric sensor.

16. The acoustic ear fitting of claim 14, wherein the biosensor is a bioelectric biometric sensor.

17. An acoustic ear fitting comprising:
a compliant scaffold; and
an air permeable membrane coupled to the compliant scaffold, the air permeable membrane being comprised of a plurality of porous fluoropolymer layers including a porous fluoropolymer layer having a microstructure including a fold and an elastomer applied to the air permeable membrane such that the elastomer encapsulates a portion of the fold in the microstructure.

18. The acoustic ear fitting of claim 17, wherein the elastomer operates to maintain the fold in the absence of an eternal force being applied to deform the fold.

19. The acoustic ear fitting of claim 17, wherein air is permitted to flow through channels within the microstructure of the plurality of porous fluoropolymer layers.

20. The acoustic ear fitting of claim 17, wherein the air permeable membrane is vapor permeable.

21. The acoustic ear fitting of claim 17, wherein the air permeable membrane is liquid impermeable.

22. The acoustic ear fitting of claim 17, wherein the fluoropolymer is expanded polytetrafluoroethylene.

23. A method of forming an acoustic ear fitting, the method comprising:
applying an elastomer to a portion of less than all of a structured porous fluoropolymer membrane to form a composite cover, the structured porous fluoropolymer membrane having a microstructure including a fold, the elastomer being applied to the structured porous fluoropolymer membrane such that the elastomer encapsulates a portion of the fold in the microstructure, the composite cover being air permeable; and
stretching the composite cover over a core member such that the composite cover is elastically tensioned about the core member.

24. A method of forming an acoustic ear fitting, the method comprising:
applying an elastomer to a portion of less than all of a structured porous fluoropolymer membrane to from a composite cover, the structured porous fluoropolymer membrane having a microstructure including a fold, the elastomer being applied to the structured porous fluoropolymer membrane such that the elastomer encapsulates a portion of the fold in the microstructure, the composite cover being air permeable;
preforming the composite cover such that the composite cover adopts a designated shape when supported, the preformed composite cover including a void; and
injecting a core material into the void such that the core material stretches and supports the composite cover in the designated shape.
